(19) United States
(12) Patent Application Publication
(10) Pub. No.: US 2012/0308704 A1
(43) Pub. Date: Dec. 6, 2012

(54) Emulsion or Gel for Producing food Products Including Omega-3 Fatty Acid

(76) Inventors: Peter Eisner, Freising (DE); Christian Zacherl, Freising (DE); Andreas Nuske, Donaueschingen (DE)

(21) Appl. No.: 13/309,689

(22) Filed: Dec. 2, 2011

Related U.S. Application Data
(63) Continuation of application No. PCT/DE2010/000408, filed on Apr. 12, 2010.

(30) Foreign Application Priority Data
Jun. 2, 2009 (DE) DE102009023 482.9

(51) Int. Cl. A23L 1/314; A23D 7/06; A23L 1/317; C11B 5/00; A23P 1/00

(52) U.S. Cl. 426/545; 426/542; 426/519; 426/518

(57) ABSTRACT

An emulsion as an ingredient or additive for producing food products including omega-3 fatty acids, the emulsion including an outer water phase including at least one water soluble antioxidant that is dissolved in water; and an inner fat or oil phase which includes plant oil droplets provided with at least one fat or oil soluble antioxidant and with omega-3 fatty acid ester, wherein the plant oil droplets are respectively provided with a shell made from plant protein.

### RELATED APPLICATIONS

This application is a continuation of International application PCT/DE2010/000408 filed on Apr. 12, 2010 claiming priority from German application DE 10 2009 023 482.9 filed on Jun. 2, 2009, both of which are incorporated in their entirety by this reference.

### FIELD OF THE INVENTION

The present invention relates to an emulsion or a gel as an additive or ingredient for producing food products including omega-3 fatty acids, a method for producing the emulsion or the gel and using the emulsion or the gel for producing food products.

Today food products are not only intended to provide nutritional supply to the consumer. They are rather also intended to preserve the performance potential of the consumer and to protect his health against damages caused by stress and chronical illnesses. Elementary tasks are improving regeneration, stabilizing the immune system and protecting the heart and these can be influenced through proper nutrition. Thus, the supplementation or enrichment of food products with natural and non-synthetic nutrients is important. Nutrients like omega-3 fatty acids, coenzyme QIO, L-carnitin, amino acids and other substances are thus considered beneficial to a person's health.

### BACKGROUND OF THE INVENTION

Thus, more and more so called functional foods or functional food supplements are being produced. Among these functional food products or food supplements the ones including omega-3 fatty acids become more and more important.

In particular the omega-3 fatty acids included in cold sea water fish (e.g. salmon, mackerel, tuna and herring) protect against arterial sclerosis, they support the immune system and improve mental performance and the general mood. Furthermore omega-3 fatty acids are also used in plant oils like soybean oil, olive oil, sunflower oil, linseed oil or rapeseed oil or also in fish oils and the oils and fats of algae.

The omega-3 fatty acids docosahexaenoic acid subsequently abbreviated DHA and eicosapentaenoic acid subsequently abbreviated EPA can be found in sufficient quantities in cold salt water fish (e.g. mackerel, tuna, herring or salmon) and in plants in the form of alpha linoleic acid (C 18:3). The fatty acids are concentrated in fat tissue in the cold sea water fish, in particular in the so called fish fillet.

As described in DE 38 13 805 A fish oils including EPA and DHA are used for producing EPA and DHA containing preparations, wherein the fatty acids are provided as triglycerides or esters of lower alcohols. The alkyl esters obtained from the triglycerides through ester interchange with lower alkanols have the advantage of being particularly suitable for concentrating EPA and DHA.

A problem when producing preparations including EPA and DHA is the smell which is also maintained after ester interchange and concentration of EPA and DHA. This strong smell and the strong fish taste, in particular when using fish oils as a carrier substance for EPA and DHA is caused by the oxidative breakdown of the highly unsaturated fatty acids. These are mostly unsaturated carbonyl compounds which can smell intensely already at very low concentrations.

For these reasons using a liquid EPA and DHA including fish or plant oil as an additive in food products and products with long shelf life and a long storage duration on the distributor shelf or at a consumer has not been advisable so far. The known problem of high oxidation propensity of omega-3 fatty acids occurs in particular when sausage products are enriched with EPA and DHA including fish oils.

Thus it is desirable in any case to eliminate the high oxidation propensity of functional food products enriched with omega-3 fatty acids already during production of the food products.

### BRIEF SUMMARY OF THE INVENTION

Therefore it is an object of the invention to find a way to enrich or provide functional food products with omega-3 fatty acids, without the food products then having the high oxidation propensity that is proprietary to omega-3 fatty acids.

It is the core idea of the invention to use an emulsion for producing food products that include omega-3 fatty acids, wherein the emulsion includes the following:
a) an outer water phase (continuous phase) including at least one water soluble antioxidant that is dissolved in water; and
b) an inner fat or oil phase (disperse phase) which includes oil droplets made from plant oil provided with at least one fat or oil soluble antioxidant and with omega-3 fatty acid esters, wherein the plant oil droplets are respectively provided with a shell made from plant protein.

The composition of the emulsion 1 is illustrated in particular in FIG. 1, wherein the aqueous phase 2 (outer phase or continuous phase) of the emulsion 1 is enriched with at least one water soluble antioxidant. The fat or oil phase (inner phase or disperse phase) of the emulsion 1 is enriched with at least one fat or oil soluble antioxidant and includes oil droplets 6 made from plant oil provided with omega-3 fatty acid ester 8, wherein the plant oil droplets 6 are respectively enveloped by a plant protein shell 10.

An emulsion 1 of this type is used for producing food materials, wherein a food product according to the invention includes animal food products and food products for human consumption. When an emulsion 1 of this type is used for producing food products this has the following advantages:
The at least one fat soluble antioxidant provided in the fat or oil phase 4 prevents an oxidation of the omega-3 fatty acid esters 8 within the plant oil droplets 6 which renders the emulsion 1 smell neutral. Furthermore the fat soluble antioxidant also prevents an oxidation of the plant oil 6 itself which is a problem in particular for sausage products enriched with plant oil.
The at least one water soluble antioxidant included in the water phase 2 of the emulsion 1 prevents an agglomeration of oxygen molecules in the water phase 2.
The plant protein shell 10 of the plant oil droplets 6 retards the diffusion of oxygen molecules and forces a longer contact time between the water soluble antioxidant in the water phase 2 and the oxygen molecules.
The oil soluble antioxidant prevents an oxidation of the omega-3 fatty acid esters 8 bonded in the plant oil droplets 6.

Consequently oxygen in order to oxidize the omega-3 fatty acid esters 8 bonded in the plant oil droplets 6 initially has to pass the at least one water soluble antioxidant. The oxygen molecules which can pass the water phase 2 then additionally have to permeate the shell 10 made from plant protein which respectively envelopes or surrounds a plant oil droplet 6. The plant protein shell 10 retards the diffusion of the oxygen molecules and forces a longer contact time between the water soluble antioxidant in the water phase 2 and the oxygen molecules. This has the effect that the oxygen molecules which pass this obstacle are eventually rendered harmless by the oil soluble antioxidant in the plant oil droplets 6 so that essentially no oxygen can pass through to the omega-3 fatty acid ester 8. The described emulsion is very stable against oxidation for the grounds recited supra.

Alternatively the object of the invention is achieved through a gel for producing food products including omega-3 fatty acid, wherein the gel is formed by a finely dispersed system including:
a) denaturized plant protein;
b) water provided with at least one water soluble antioxidant; and
c) bonded oil droplets made from plant oil provided with at least one fat or oil soluble antioxidant and with omega-3 fatty acid ester.

This gel is advantageously obtained by heating the emulsion described supra over a time period of 15 to 240 minutes to a temperature of 40° C. to 85° C. The gel has the same advantages as the basic emulsion. A specific advantage of the gel is furthermore that it promotes stabilization of the emulsion and in particular of the oil droplets within the water phase.

Advantageously the at least one water soluble antioxidant includes citric acid and/or ascorbic acid. In particular a combination of citric acid and ascorbic acid provides a particularly oxidation stable emulsion.

According to another embodiment the omega-3 fatty acid esters 8 can be esters of the highly saturated fatty acids eicosapentaenoic acid (EPA) and docosahexaenoic acid (DHA). Methods for producing a fatty acid alkyl ester, for example, through inter estering triglycerides which are included in a plurality of oils and fats is well known, for example from DE 699 31 897 T2. Omega-3 fatty acid esters have an advantage over triglycerides in that they are more hydrophilic and therefore better bondable in the emulsion.

For example the plant oil which configures the plant oil droplets 6 in the emulsion or in the gel can be walnut oil, rapeseed oil, linseed oil, chia oil, hemp oil, soybean oil, perilla oil or a mix including at least two of the above oils.

The at least one fat or oil soluble antioxidant advantageously includes α-tocopherol (vitamin E).

The emulsion 1 or the gel produced there from is advantageously packaged as a finished product as an additive or ingredient for producing food products for humans and/or animals in suitable airtight packages and also offered as a product that is being sold independently.

Alternatively the finished emulsion 1 or the finished gel is directly mixed into the food product and the latter is then, for example, packaged airtight as a marketable product.

The method for producing the emulsion according to FIG. 2 includes at least the following steps:

a) Dissolving at least one water soluble antioxidant in water for forming a aqueous solution including at least one water soluble antioxidant;

b) introducing at least one plant protein into the solution obtained under step a) for forming a homogeneous aqueous solution including the at least one water soluble antioxidant and the at least one plant protein; and before, parallel to or after the steps a) and b):

c) introducing at least one fat or oil soluble antioxidant in plant oil for forming a mix from plant oil and fat or oil soluble antioxidant;

d) introducing omega-3 fatty acid ester into the plant oil mix obtained from step c) and the at least one fat or oil soluble antioxidant for forming a mix from omega-3 fatty acid ester, plant oil and fat or oil soluble antioxidant;

e) dosing the mix obtained from step d) including omega 3 fatty acid ester, plant oil and fat or oil soluble antioxidant into the aqueous solution obtained through step b) including the at least one water soluble antioxidant and the at least one plant protein; and

f) homogenizing the mix from omega-3 fatty acid ester, plant oil and fat or oil soluble antioxidant on the one hand side and the aqueous solution including at least one water soluble antioxidant and the at least one plant protein on the other hand side for forming the emulsion.

According to one alternative, introducing omega-3 fatty acid ester into the mix obtained through step c) including plant oil and the at least one fat or oil soluble antioxidant can be omitted. Then the oil or fat-phase of the emulsion only includes plant oil and fat or oil soluble antioxidant. As a result, an emulsion is obtained in this case including the following:

a) an outer water phase which includes at least a water soluble antioxidant that is dissolved in water; and

b) an inner fat or oil phase which includes oil droplets including plant oil which are provided with at least one fat or oil soluble antioxidant, wherein the plant oil droplets are respectively enveloped by a plant protein shell.

### BRIEF DESCRPTION OF THE DRAWINGS

The features of the present invention and additional advantages are now described based on advantageous embodiments with reference to drawing figures, wherein:

FIG. 1 illustrates a composition of an emulsion according to the invention; and

FIG. 2 illustrates a method for producing an emulsion according to the invention.

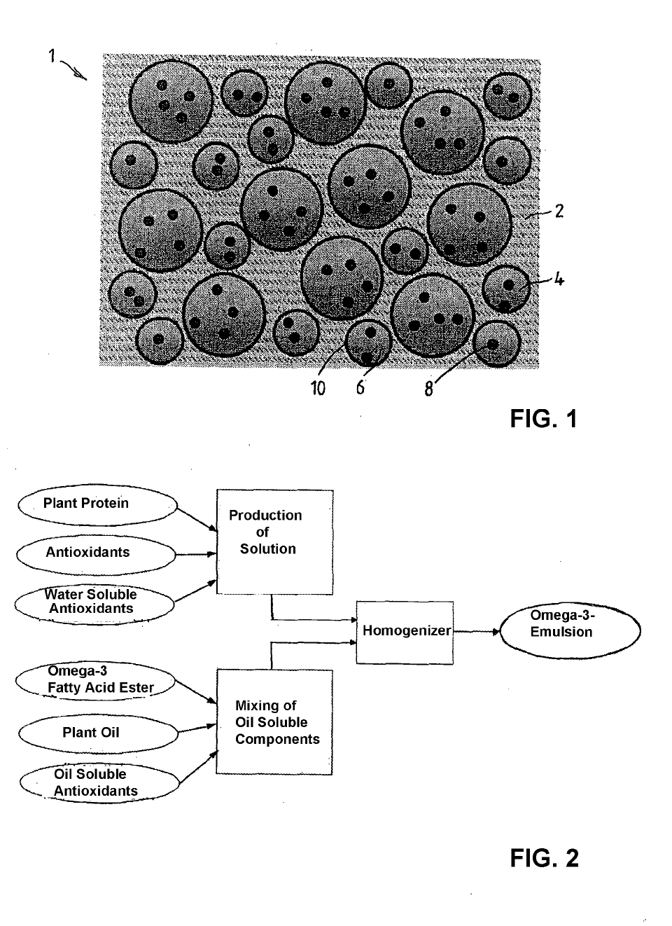

### DETAILED DESCRIPTION OF THE INVENTION

Introducing at least one plant protein is, for example, performed through a spiral mixer or a colloid mill, the optional introduction of omega-3 fatty acid ester into the mix including plant oil or fat or oil soluble antioxidants is advantageously performed under an inert gas atmosphere which excludes oxygen and includes, for example, 80% N₂ and 20% CO₂.

Dosing the mix including omega-3 fatty acid ester, plant oil and fat or oil soluble antioxidant into the aqueous solution including the at least one water soluble antioxidant and the at least one plant protein is advantageously provided in that the aqueous solution including the outer water phase is prepared in a dispersion unit like a gear ring dispersion machine or a colloid mill and the mix of plant oil, fat or oil soluble antioxidant and optional omega 3 fatty acid ester forming the inner oil phase of the emulsion is continuously dosed into the mix.

When dosing the oil or fat-phase into the water-phase, the process temperature is advantageously less than 20° C., in particular less than 10° C. Homogenizing the mix from oil-phase and water-phase is provided, for example, in a homogenizer or in a high-pressure homogenizer.

Therefore, initially advantageously the soluble antioxidants (citric acid, ascorbic acid) are solved in water. Subsequently, the plant protein is introduced into the solution. For better dissolving either a coil mixer or for particularly highly concentrated mixtures a colloid mill is used. After this process step, a homogenous aqueous solution including plant protein and antioxidants is provided.

In the next step, advantageously the oil soluble antioxidants are stirred into plant oil. Advantageously only thereafter, the optional omega 3 fatty acid esters are stirred into the oil antioxidant mix, thus in a liquid, gel or powder form. This has the advantage that the omega 3 fatty acid esters which were previously stored under an inert gas atmosphere and under oxygen exclusion and which briefly are in contact with oxygen after opening the package during dosing, are immediately mixed into an antioxidative environment (oil antioxidant mix) and thus oxidation effects are prevented as far as possible.

In a particularly advantageous manner, dosing and mixing is also provided under an inert gas atmosphere, for example, under the exclusion of oxygen and 80% N₂ and 20% CO₂.

The water protein antioxidant mix is prepared in a dispersion unit (either a gear ring dispersion machine or a colloid mill). The mix is pumped in a cycle and simultaneously the oil mix is continuously added through dosing. Through the dispersion unit, the oil phase is homogenously distributed in the aqueous phase and pre-emulsified. The process if possible is performed at temperatures below 20° C., better below 10° C.

The pre-emulsified mix is then homogenized in the homogenizer or the high pressure homogenizer. Thus, the previously evenly distributed oil droplets are broken down into a larger number of much smaller oil droplets and thus stabilized. The emulsion produced after the homogenization process is stored as cold as possible under the exclusion of light and oxygen for further use.

### EXAMPLE 1

### Production of 25 kg Emulsion with 4% Omega-3 Fatty Acid Ester

1. Initially 14.7 kg water is prepared at 20° C.;

2. Subsequently 34 g citric acid and 68 g ascorbic acid are stirred into the water;

3. 3.06 kg of pea protein isolate are mixed in through a colloid mill, distance rotor/stator 1-2 mm, mixing time four minutes, cooling at 20° C.;

4. 6.01 kg rap seed oil is prepared, 68 g Winox (rosemary extract) is mixed in and 85 g alpha-Tocopherol are mixed in through a lab gear ring dispersion machine (Turrax), three minutes at 15,000 RPM, T=20° C., 1,020 g omega-3 ethyl ester (KD-Pharma omega-3>90EE) at 9,000 RPM for one minute at 20° C.;

5. The aqueous solution from step 3 is provided in a gear ring dispersion unit (Fryma Koruma Disholab), the oil phase from step 4 is mixed in and pre-emulsified at 700 mbar vacuum, 15° C. for 20 minute at a speed of 4,500 RPM.

6. The pre-emulsion of step 5 is homogenized through a high pressure homogenizer APV2000 at 500 bar in one step, temperature 15 to 20° C.;

7. The emulsion is packaged under vacuum or inert gas (80% N₂ and 20% CO₂) and cooled at 1° C.

In order to prepare the gel from the emulsion, the emulsion is advantageously heated over a time period of 15 to 240 minutes to a temperature of 40° C. to 85° C. Thus, the plant protein included in the emulsion is denaturized and forms a stabilizing network about the plant oil droplets.

The emulsion or the gel can be produced with different portions of omega-3 fatty acid ester. Depending on the added amount, the percentage of omega-3 fatty acid ester in the emulsion or the gel varies advantageously between 0.0% by weight (no portion of omega-3 fatty acid ester) and 10% by weight. Higher portions than 10% by weight of omega-3 fatty acid esters are not useful because of the non-favorable texture and sensory properties of the products produced from the emulsion or the gel.

When no omega-3 fatty acid ester is introduced into the emulsion according to the alternative, the respective gel is formed through a finely dispersed system including:

a) denaturized plant protein;

b) water provided with at least one water soluble antioxidant; and

c) bonded oil droplets made from plant oil which are provided with at least one fat or oil soluble antioxidant.

Thus an emulsion or a respective gel advantageously provided with omega-3 fatty acid ester is, for example, worked into a sausage base meat at a portion of 25% by weight of the total mass, wherein the sausage produced from the sausage base meat, for example, has a content of 1% by weight of omega-3 fatty acid ester.

Thus, initially the emulsion or the gel is produced as a finished product and then worked into the sausage base meat in its entirety as an additive or ingredient during the cutting process.

Consequently, generally the raw mass including meat from at least one warm blood animal and/or from at least one fish and/or components of at least one plant is initially at least partially comminuted and then mixed with the emulsion prepared in advance or with the gel prepared in advance. The emulsion or the gel, however, is not only formed or produced during or through the comminution of the raw mass.

This has the consequence that the finished emulsion before being worked into the sausage base meat is very stable and the plant oil droplets are relatively small. Furthermore, the sausage base meat can be cut in a more gentle manner for lower shear rates, since the energy introduction for producing the emulsion has already taken place in the separate emulsification of the emulsion previously performed. Furthermore, the emulsion cannot be produced in the cutter with the same homogeneity as in a homogenizer, the sizes of the plant droplets then produced would be very different. Furthermore, much smaller plant oil droplets can be obtained in the finished emulsion through the homogenizer which leads to an advantageously stable emulsion. This in turn yields a firmer texture, a better mouth feel and taste of the sausage product produced there from.

Eventually, due to the better encapsulation of the plant oil droplets in the emulsion initially produced interfering aromatic components are very effectively minimized. Eventually, the plant proteins can function in the separate production of the emulsion in a much more concentrated manner as emulgator than for a prior dilution in the cutter through the sausage base meat.

The combination of plant oil droplets distributed in a water phase of a finished and stable emulsion and enveloped by a protein shell has additional distinct advantages.

On the one hand side, the oil droplets are very small so that they are hardly detectable in a sensory manner. Contrary thereto, gelatin capsules as oxidation protection for omega-3 fatty acids can be felt in the mouth. Furthermore, gelatin capsules are destroyed when being worked into sausage base meats during cutter operations. Subsequently, the plant oil would exit which leads to undesirable false aromatic tastes. Furthermore, gelatin is heat-reversible, this means during heating (scalding) of the sausages, gelatin capsules would melt and the plant oil would also exit. Furthermore, no defined water phase can be stabilized about gelatin capsules, so that no binding forces are provided and the antioxidants would be washed away. In an emulsion, however, the binding forces of the emulgator become effective.

The base meat mass according to the invention is on the one hand side a base meat with fine particles (e.g. from a meat grinder like a cutter) or also chopped base meat or coarse base meat (e.g. from a meat fine grinder).

Typically, a raw mass including meat from at least one warm blood animal and/or from at least one fish and/or components of at least one plant is comminuted and mixed with the emulsion or the gel. The content of the emulsion or of the gel in the raw mass is advantageously in a range between 0.0% by weight and 40% by weight, particularly advantageously in a range between 10% by weight and 25% by weight.

The base material, for example, of warm blood animals and/or fish and/or components of plants are comminuted in a comminuting device, in particular a meat comminuting device like a cutter or a meat grinder to form the raw mass. Then the emulsion or the gel is advantageously added in frozen condition to the raw mass or mixed in.

As recited supra, the raw mass is advantageously formed by a sausage base meat mass, wherein the emulsion or the gel of the sausage base meat mass is added in particular when essentially two-thirds of the entire sausage base meat production time has elapsed and during the remaining third of the entire sausage base meat production time it is distributed within the sausage base meat mass.

The emulsion or the gel is advantageously worked into the sausage base meat mass when sausage products are being produced. The portion of the emulsion or the gel in the total base meat mass is advantageously over 0.0% by weight and less than 40% by weight. Since as recited supra the content of omega-3 fatty acid esters in the emulsion or in the gel varies advantageously between 0.0% by weight (no omega-3 fatty acid ester) and 10% by weight, the content of omega-3 fatty acid ester in the total base meat mass and thus also in the subsequent sausage product is advantageously in a range between 0.0% by weight and approximately 3% by weight and individually adjustable.

At a content of 10% by weight to 25% by weight of emulsion or gel in the total base meat mass, a significant texture improvement occurs in particular when working the emulsion or gel into low fat base meat masses. The texture of the sausage becomes significantly more supple, smoother and juicier.

When working the emulsion into a base meat mass which includes fish meat, in particular also when using fish meat with a very fishy aroma and smell, a portion of 10% by weight to 25% by weight emulsion or gel in the total base meat mass achieves a substantial neutralization of the fish aroma and the fishy smell and taste components are covered up. Thus, the emulsion can have a portion of omega-3 fatty acid esters of up to 8% by weight.

Furthermore, it is also conceivable to use the emulsion or a gel without any omega-3 fatty acid esters in order to only obtain advantages with respect to sensory properties and texture of the sausage product advantageously produced as will be described in detail infra. Then, however, no enrichment with omega-3 fatty acids occurs.

As described supra, the finished emulsion or the finished gel is advantageously mixed into the sausage base meat mass during comminuting in a meat comminuting device like, for example, a cutter. The amounts of typical spices like, for example, salt are computed for the total base meat mass, that means base meat mass plus emulsion, and, for example, added at the beginning of the cutter process. Also the following additives can be added to the base meat mass: phosphate, salt, nitrate curing salt, vegetables, broth, substances including L-Carniti n, aromatic substances, taste bearing substances, natural supplements, e.g. like vitamins, minerals and trace elements, probiotic bacteria, synthetic supplements, medicines, substances similar to medicines like e.g. substances including L-carnitin (e.g. Liebig extract) or texturing devices like e.g. breading flour.

The emulsion or the gel is advantageously added in cooled or frozen condition. After working in the emulsion and finishing the cutter process, the total base meat mass is injected into shells or guts and the sausage blanks produced there from are then scalded, smoked or aged depending on the desired type of sausage (cooked sausage, scalded sausage, spread sausage, smoked sausage, raw sausage, etc.).

The emulsion according to the invention or the gel therefore is particularly suitable for producing sausage products like raw sausages, scalded sausages, cooked sausages, cooked spread sausages and minced meat products. The application, however, is not limited to these products, but can also be provided for any other food products.

In particular, the emulsion or the gel can be used for minced meat based food products, for example, hamburgers, meatloafs, minced meat sausages, meatballs, fillings for meat pies or pate in that the emulsion or the gel is worked into the minced meat mass. The raw mass for the minced meat can thus include meat from warm blood animals (e.g. pork, beef, poultry) and/or meat from fish and/or components of plants, so that also “minced meat” of purely plant origin is conceivable as raw mass, for example, so-called vegetable burgers, into which the emulsion or the gel is worked.

Therefore, when the emulsion described supra or the gel produced there from is used as additive ingredient in food products, this has numerous advantages:

When the emulsion includes omega-3 fatty acid esters, the respective food product is enriched with omega-3 fatty acid, wherein the content of omega-3 fatty acid can be controlled through the amount that is added in the emulsion or in the gel or through the amount that is added in the food product into the emulsion or in the gel. A food product which includes, for example, originally a low content of omega-3 fatty acid or no content of omega-3 fatty acid like, for example, meat from warm blood animals or from sweet water fish or from salt water fish living in warm oceans, can thus be supplemented as a functional food product through the positive properties of omega-3 fatty acids described supra.

Based on the comprehensive oxidation protection of the emulsion or the gel described supra, the omega-3 fatty acid esters optionally included therein do not tend to oxidize. Consequently, smell formation is substantially prevented for the emulsion or the gel. The emulsion or the gel is therefore particularly suitable as an additive for food products and products with long shelf life in a store or at the consumer.

When the finished emulsion or the gel is worked into comminuted raw masses that include fish meat, for example, like a sausage base meat mass including fish meat or a ragout including fish meat, the antioxidants provided in the water phase of the emulsion or of the gel that are water soluble and have an acidic effect (pH<7) and which initially are only provided as a protection against oxidation of the omega-3 fatty acid esters of the emulsion or the gel have the additional effect that a significantly neutral taste is provided in the fish meat as has been shown by sensory trials of the applicant. Comminuted fish meat that is provided with the emulsion or the gel thus had a lesser fish aroma than the fish meat without the emulsion or gel addition. Therefore, food products made from a fish meat thus enriched, like, for example, sausage products including fish meat, would have a higher acceptance at the user than prior art products. Then it is possible to produce fish meat based products like, for example, fish sausages and still suppress the typical fish taste so that the end products do not only look like conventional meat products but in particular also have their taste. The effect of reducing the fishy aromas occurs in particular independently from whether the emulsion or the gel includes omega-3 fatty acid esters or not.

When the finished emulsion is worked into comminuted raw masses like sausage base meat masses based on meat from warm blood animals like pork, beef or poultry, it is appreciated that the proprietary taste of the meat itself is reduced and the taste of herbs and spices typically added to the meat is significantly reinforced. Thus, for meat based food products produced through the emulsion or the gel, an addition of taste reinforcing substances and aromas like glutamate can be omitted. Also this positive effect occurs irrespective of whether the emulsion or the gel includes omega-3 fatty acid esters or not.

An essential advantage of using the emulsion or the gel as an additive in food products like sausage base meats or ground meat base meats based on comminuted raw masses is the substantial improvement of the texture of food products thus produced (sausage products, hamburgers, meatloafs, meatballs, etc.). In particular improved bite firmness, homogeneity, water bonding capability and juiciness of products was achieved, into whose comminuted raw mass the emulsion or the gel was worked, compared to a product produced without the emulsion or the gel. The comminuted raw mass can thus include meat from at least one warm blood animal and/or a fish and/or components of at least one plant. Last but not least, this positive effect occurs no matter whether the emulsion or the gel includes omega-3 fatty acid esters or not.

### EXAMPLE 2

### Production of Poultry-Beef Sausage with 1% Content of Omega-3 Fatty Acid Content by Weight

| | Amount | Amount |
|---|---|---|
| Ingredient | [% weight] | [g] |
| Meat, Beef, lean | 10.34 | 2000 |
| Meat, Turkey, lean | 41.37 | 8000 |
| Ice, −20° C. to −50° C. | 20.17 | 3900 |
| Nitrate Curing Salt | 1.40 | 270 |
| Phosphate with red agent | 0.27 | 52.5 |
| Spice | 0.59 | 114 |
| Omega-Emulsion (4% omega-3 Fatty Acid Ester) | 25.86 | 5000 |
| Total | 100 | 19336.5 |
| Cutter Speed [RPM] | 3600 | |
| Cutter time [min] | 8 | |
| End Temperature [° C.] | 8-10 | |
| Introduction of Emulsion after ⅔ cutter time | | |
| Mixing | | |
| Filling | | |
| Scalding Temperature [° C.] | 72 | |
| Scalding Time [min] | 120-150 | |
| Cooling Temperature [° C.] | 5-7 | |

### EXAMPLE 3

### Production of a Fish Sausage without Omega-3 Fatty Acid Content

| | Amount | Amount |
|---|---|---|
| Ingredient | [% weight] | [g] |
| Fish filets | 63.26 | 5500 |
| Ice, −20° C. to −50° C. | 9.78 | 850 |
| Nitrate Curing Salt | 1.75 | 152 |
| Spice | 0.21 | 18 |
| Omega-Emulsion (4% omega-3 Fatty Acid Ester) | 25.01 | 2174 |
| Total | 100 | 8694 |
| Cutter Speed [RPM] | 3600 | |
| Cutter time [min] | 8 | |
| End Temperature [° C.] | 8-10 | |
| Introduction of Emulsion after ⅔ cutter time | | |
| Mixing | | |
| Filling | | |
| Scalding Temperature [° C.] | 72 | |
| Scalding Time [min] | 120-150 | |
| Cooling Temperature [° C.] | 5-7 | |

What is claimed is:

1. An emulsion as an ingredient or additive for producing food products including omega-3 fatty acids, the emulsion comprising:
an outer water phase including at least one water soluble antioxidant dissolved in water; and
an inner fat or oil phase which includes plant oil droplets provided with at least one fat or oil soluble antioxidant and with an omega-3 fatty acid ester,
wherein the plant oil droplets are provided with a shell made from plant protein.

2. A gel as an additive or ingredient for producing food products including an omega-3 fatty acid, wherein the gel is formed by a finely dispersed system, comprising:
denaturized plant protein;
water provided with at least one water soluble antioxidant; and
bonded plant oil droplets provided with at least one fat or oil soluble antioxidant and an omega-3 fatty acid ester.

3. The emulsion or the gel according to claim 1, wherein the at least one water soluble antioxidant includes citric acid or ascorbic acid.

4. The emulsion or the gel according claim 1, wherein to the omega-3 fatty acid ester include esters of highly non-saturated fatty acids eicosapentaenoic acid and docosahexaenoic acids.

5. The emulsion or the gel according to claim 1, wherein the plant protein includes protein from peas.

6. The emulsion or the gel according to claim 1, wherein the plant protein includes walnut oil, rap seed oil, lin seed oil, chia oil, hemp oil, soy oil, perilla oil or a mix including at least two of the oils.

7. The emulsion or the gel according to claim 1, wherein the at least one fat or oil soluble antioxidant includes α-tocopherol.

8. A method for producing an emulsion including at least the following steps:
a) dissolving at least one water soluble antioxidant in water for forming a aqueous solution including the at least one water soluble antioxidant;
b) introducing at least one plant protein into the aqueous solution for forming a homogeneous aqueous solution including the at least one water soluble antioxidant and the at least one plant protein;
before, parallel to or after the steps a) and b):
c) introducing at least one fat or oil soluble antioxidant in plant oil for forming a mix from plant oil and fat or oil soluble antioxidant;
d) introducing an omega-3 fatty acid ester into the mix obtained from step c) and the at least one fat or oil soluble antioxidant for forming a mix from the omega-3 fatty acid ester, plant oil and fat or oil soluble antioxidant;
e) dosing the mix obtained from step d) including omega-3 fatty acid ester, plant oil and fat or oil soluble antioxidant into the aqueous solution obtained through step b) including the at least one water soluble antioxidant and the at least one plant protein; and
f) homogenizing the mix from omega-3 fatty acid ester, plant oil and fat or oil soluble antioxidant on the one hand side and the aqueous solution including at least one water soluble antioxidant and the at least one plant protein on the other hand side for forming the emulsion.

9. The method for producing an emulsion according to claim 8, wherein introducing at the least one plant protein according to step b) is performed through a spiral mixer or a colloid mill.

10. The method for producing an emulsion according to claim 8, wherein introducing omega-3 fatty acid ester into the mix including plant oil and fat or oil soluble antioxidant according to step d) is performed under an inert gas atmosphere.

11. The method for producing an emulsion according to claim 8, wherein the dosing according to step e) is provided in that the aqueous solution forming the outer water phase and including the at least one water soluble antioxidant and the at least one plant protein is provided in a dispersion unit and the mix of omega-3 fatty acid ester, plant oil and fat or oil soluble antioxidant forming the inner oil phase of the emulsion is continuously dosed into this mix.

12. The method for producing the emulsion according to claim 11, wherein a process temperature is less than 20° C. during dosing the inner oil phase into the outer water phase according to step e).

13. The method for producing an emulsion according to claim 8, wherein the homogenizing according to step f) is performed in a homogenizer or high pressure homogenizer.

14. The method for producing a gel from an emulsion produced according to claim 8, wherein the emulsion is heated to a temperature of 40° C. to 85° C. over a time period of 15 to 240 minutes.

15. A use of an emulsion or a gel according to claim 1 for producing food products for humans or animals.

16. The use according to claim 15, wherein a raw mass including meat from at least one warm blood animal or at least one fish or components from at least one plant is partially comminuted and then mixed with the previously prepared emulsion or with the previously prepared gel.

17. The use according to claim 16, wherein the content of the emulsion or the gel in the raw mass is in a range greater of than 0.0% by weight and less than 40% by weight.

18. The use according to claim 17, wherein the content of the emulsion or the gel in the raw mass is in a range of 10% by weight to 25% by weight.

19. The use according to claim 16, wherein the raw mass is comminuted in a meat comminuting device like a cutter or a meat grinder.

20. The use according to claim 16, wherein the emulsion or the gel is added to the raw mass in frozen condition.

21. The use according to claim 16, wherein for producing sausage products, wherein the raw mass includes a sausage base meat mass.

22. The use according to claim 21,
wherein the previously prepared emulsion or the previously prepared gel is added to the sausage base meat mass when essentially two-thirds of an entire sausage base meat mass production time has elapsed, and
wherein the previously prepared emulsion or the previously prepared gel is distributed within the sausage base meat mass during a remaining third of the entire sausage base meat production time.

23. The use according to claim 16 for producing minced meat based food products, wherein the raw mass includes minced meat.

24. The emulsion or the gel according to claim 2, wherein the at least one water soluble antioxidant includes citric acid or ascorbic acid.

25. The emulsion or the gel according claim 2, wherein to the omega-3 fatty acid ester include esters of highly non-saturated fatty acids eicosapentaenoic acid and docosahexaenoic acids.

26. The emulsion or the gel according to claim 2, wherein the plant protein includes protein from peas.

27. The emulsion or the gel according to claim 2, wherein the plant protein includes walnut oil, rap seed oil, lin seed oil, chia oil, hemp oil, soy oil, perilla oil or a mix including at least two of the oils.

28. The emulsion or the gel according to claim 2, wherein the at least one fat or oil soluble antioxidant includes α-tocopherol.
